(19) United States
(12) Patent Application Publication
(10) Pub. No.: US 2009/0114506 A1
(43) Pub. Date: May 7, 2009

(54) Unmanned object conveyer system

(76) Inventor: Chang-Jen Chen, Taipei City (TW)

Correspondence Address: Chen, Chang-Jen, P.O.Box 44-2049, Taipei, 10668, TW

(21) Appl. No.: 11/979,655

(22) Filed: Nov. 7, 2007

(51) Int. Cl. B65G 43/10; G06F 7/00; G06Q 30/00

(52) U.S. Cl. 198/341.01; 700/215; 705/1

(57) ABSTRACT

The present invention provides an unmanned object conveyer system, which is a combined system composed of information management system center, center website, logistic center, and a plurality of space aggregate. The object of the present invention is to meet the requirement of conveying objects to another place, and an unmanned conveyer method for the logistic center conducting conveyance among each storage space aggregate, so that the sender or the receiver could complete the object conveyance under free time and space by granting the digital code through the center website and the establishment of information system, the monitoring and management of information management system center, and the storage and safekeeping for the storage space aggregate, management of access control system, and even account management.

### BACKGROUND OF THE INVENTION

(1) Field of the Invention

The present invention relates to an unmanned system for physical object conveyance in a virtual network environment, and particularly to a networking system constituted by object conveyance method using different combination of digital codes and unmanned storage space aggregate.

(2) Description of the Prior Art

The conventional remote object conveyance methods include the registered mail, express, freight transport, distribution and home distribution. The registered mail method is usually that the sender must send the object to the post office for consignation, and the post office will distribute unified to each local post office, and dispatch the postmen to directly send to the address of the receiver. This kind of process flow not only needs very long traffic time, but also have to spend the time for registration, aggregation, coordination and waiting to be dispatched. However, not every place is established with a post office, so that the delivery time for an object might usually take few days; moreover, it is important that, for the safety issue, the receiving address for the registered mail must have somebody to receive, otherwise it will wait until the receiver got the left note from the post office and went to the post office to pick up the mail. It is very common to take one or two weeks for receiving. And, the sender must choose to mail the object during business hours of the post office. Thus, the people who could not go to the post office for mailing object within business hours of post office would feel very inconvenient. For the case that the object should be urgently delivered to the receiver due to timing effect, the registered mail would cause people a lot of troubles. Thus, the methods for object conveyance have been added with an express model, in which the sender needs not to go to the post office, and the express operator will come picking up at house, and deliver the object directly to the receiver.

Although it could eliminate the trouble for the sender on timing effect issues, it will have the problem of higher expense. Especially during the period of highly raised oil price, the fright heavily related to the oil price would be feasible for high priced object, but be another trouble for the low priced object.

The freight transport and distribution are commonly employed for the company and store on goods distribution. Although the fright transport is to pick up at the sender's place, the expense for on-site picking up will be relatively increased. The distribution is only for the channel operators. The house distribution is a delivery method between express and post office for replacing the post office with the convenient store, which is the most beneficial in that: the convenient store is normally operating 24 hours a day, so the sender will have the freedom for the timing, but the expense is almost the same as the express, and not economical eventually.

Recently, because the network auction is very popular, no matter first completing the remittance, then sending the object, or first sending the object then completing remittance, there are always some problems. It might be feasible for high priced objects, but the expense would be the biggest issue between seller and buyer for the low priced object.

In the era of M-type society, the enterprise scale is M-type, the economical model is M-type, the market price is M-type, and the wage structure is M-type. The keen competition is not only for the pricing issue, but also appeared on the freight, the timing effect, the convenience, the privacy, the autonomy, the private right, and the mostly emphasized freedom by the modern people. However, the current object conveyance methods could not be compliant with the requirement of modern people.

If the sender could not go to the post office at day time to mail the object, he has to spend more freight. If the sender does not have fixed working place or residence, or the time for the working space and residence is not stable, it would be a great problem to receive the object.

However, for an object provider, it would be the biggest obstruction for marketing due to high freight and inconvenience.

### SUMMARY OF THE INVENTION

One of the main objects of the present invention is to provide an object exchange space that the sender and the receiver could employ anytime.

The second one of the main objects of the present invention is to provide a conveyance platform led, monitored and managed by the network, which could greatly reduce the cost for object conveyance.

The third one of the main objects of the present invention is to provide an object conveyance system with convenience, privacy, autonomy, private right, and the most emphasized freedom by the modern people.

The fourth one of the main objects of the present invention is to provide an unmanned object conveyance system, which is an object conveyance scheme with lowest cost on the personnel expense and system establishment.

The fifth one of the main objects of the present invention is to provide a commercial operating space with highest space cycling utility. The sixth one of the main objects of the present invention is to provide an operation model with remote management, 24-hour operation and highest performance.

The last object of the present invention is to provide an object conveyance system for the public, which is an object conveyance space that the small or micro business, the network auction operators, the ordinary individual could employ.

The application environment according to the present invention includes: the conveyance instruction requester, the sender, the receiver, the center website, the information management system center, the logistic center, and the storage space aggregate. The key point of the present invention is crossed space-time object conveyance system, which is a software or hardware or combination of software and hardware for information transformation through Internet and conveyance of physical objects.

To this end, the object conveyance system according to the present invention employs an unmanned method and Internet system to place the objects in storage boxes configured at every place, so that the sender and the receiver could freely store and pick objects at the time and the location selected by themselves without the interference of service personnel, and the sender and the receiver could enjoy the maximum freedom under the maximum free space and time, and achieve the lowest delivery cost.

The conveyance system according to the present invention mainly comprises: a means for conveying instruction requesting the center website to provide the conveyance service; a means of digital code confirmation, in which the center website will combine the request issued by the conveyance instruction requester and the related storage space information provided by the information management system center, and grant with several sets of codes including object storage digital code and confirmation code, object pick-up digital code and confirmation code; a means for the center website granting the logistic center with the conveyance information and the digital code sets of object pick-up and conveyance through the information management system center; a logistic means for the logistic center; and, a receiver pick-up means.

Firstly, the present invention is to configure an information management system center, a center website, a logistic center, and a storage space aggregate; wherein, the storage space aggregate could be configured at every place according to the requirement, and the information management system center will proceed with the remote monitoring and management through Internet monitoring. Inside the storage space aggregate is configured with a monitoring system, an access control authorization system, an input device, an information transmission system, and an accounting management system.

For the request of the requirement for delivering objects to another place, the so-called conveyance instruction requester could issue the service request through the center website. The center website will be based on the application content of the requester, including the name of the object storage person, the name of the stored object, the stored address, the stored time, the destination, the desired delivery time, and the delivery conditions, such as whether to collect money on sender's behalf; and, except for the payment method of the contracted service fee, it will provide the storage space address of the location accessed by the applicant, and the key digital codes, which is the most important issue in this service, and it will notify the information management system center and the logistic center entering the registration statue. This set of digital codes could provide the most critical information for the object conveyance of the application, such as the pick-up time, the location, the conditions, etc., and the applicant will attach the set of digital codes on the surface of the object package. Therefore, when the conveyance instruction requester bring the object to be delivered in person or ask the sender to bring to the assigned storage space aggregate address, he must present the password or barcode attached on the package surface of the object to pass the access control authorization system of storage space aggregate address, and then successfully find the storage space assigned by the information management system center, and store the object attached with the digital codes after confirmation.

After the storage of the object attached with digital code, the information management system center will command the mission at the next stage based on the content indicated by the digital codes. If the content is only to notify the receiver to pick up at the storage space aggregate at the specified address, the information management system will notify the center website to immediately issue the arrival notice to the receiver and ask the receiver for confirmation; then, based on the request of the conveyance instruction requester, providing another set of digital codes for the receive to pick up at the storage space aggregate; if it is required for collecting money on sender's behalf, the information management system center will issue an information notification to the storage space aggregate that it must be completed with accounting procedure before allowing passing through. Thus, the system could assure that the transaction between the applicant and the receiver could be completed under the safest status. If the address of the storage space aggregate for the applicant to deposit is different from the address requested by the receiver, or the storing address of the storage space aggregate assigned for pick-up by the applicant is different from the storing address of the storage space aggregate, it could employ the logistic system among each storage space aggregate to achieve the conveyance purpose.

The biggest feature of the present invention is that: except for the storage space aggregates, the information management system centers, the center websites, and the logistic centers widely configured at each place, most importantly, the entire conveyance system employs various different combinations of digital codes providing different statuses of people with different types of missions for object conveyance and also achieving the purpose of private right protection. The present invention provides an unmanned logistic free opened space, so that every one could employ this system to deliver the objects to be delivered for the requirement of individual or company to any place configured with the storage space aggregate; and, also with such kind of system to receive the objects conveyed by the storage space aggregates; most importantly, with this unmanned system, being freely determined with the delivery or pick-up time, and a freely determined storage space, every one could achieve the conveyance purpose through the network.

The second feature of the present invention is to provide a two-way or multi-way conveyance channel, and the conveyance instruction requester could be the sender, and also could be the receiver, and through the public and access-controlled storage space to provide the people in mobile era with a free space indicated and selected through the network.

The third feature of the present invention is to reduce the process of conveyance operation and the distance of time-space, transform passive to active, so as to properly employ the best conveyance channel and delivery time to achieve the best economical benefit.

When the conveyance instruction requester has several objects to be delivered to different receivers at the same time, he only needs to write down the address of the receiver storage space aggregate on the outer package for each object, and attach with the digital codes got from the center website, and then the objects will be delivered respectively to the storage space aggregate assigned for each object through the logistic center, and being delivered to the receiver through the notification of the information management system center or the center website.

The center website will provide different combination of digital codes to different targets. For the sender, the function of the digital codes is the access control authorization for passing the storage space aggregate of the specified address and the digital codes as the pick-up conditions for the receiver; for the logistic center, the most important information in the digital codes is the address of the receiver storage space aggregate and the arrival time. The acquirement for each set of digital codes represents different statuses. The kind of design for digital codes employs the input to deliver the information to the information management system center to form the most private conveyance system.

### BRIEF DESCRIPTION OF THE DRAWINGS

FIG. 1 is a flow diagram of an embodiment according to the present invention.

### DETAILED DESCRIPTION OF THE PREFERRED EMBODIMENTS

The technical content and detailed description according to the present invention will be described with the attaché figures as follows:

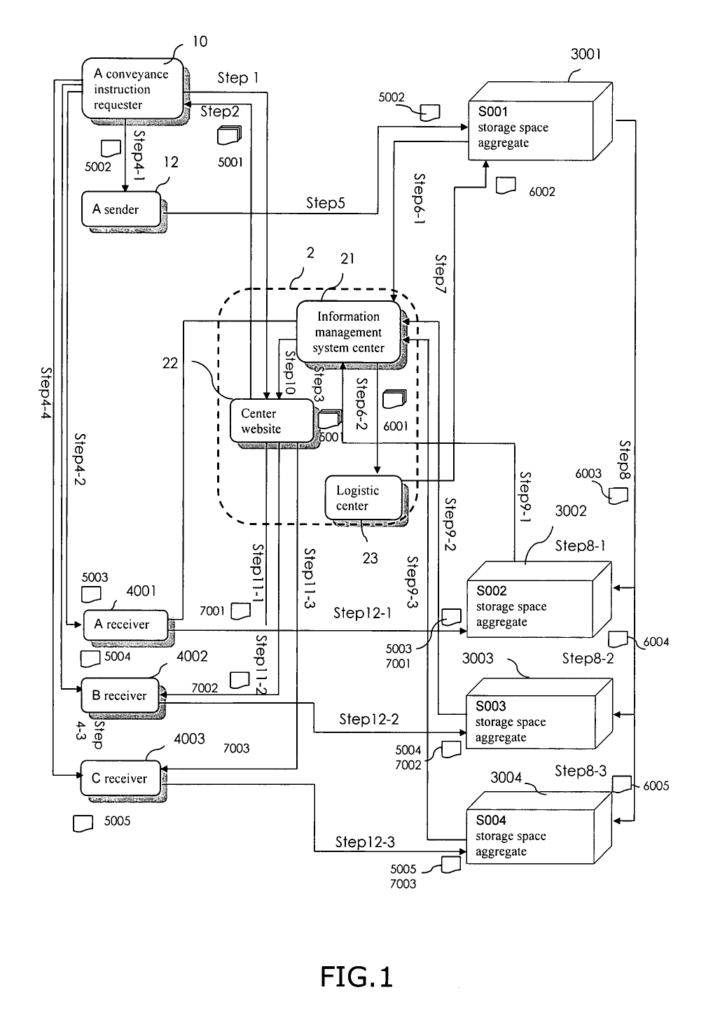

FIG. 1 is a flow diagram of an embodiment according to the present invention. The implementation prerequisites of the embodiment are: 1. the conveyance instruction requester is not the sender, and also not the receiver; 2. the sending will have three objects at the same time for sending to A, B, C three different receivers, respectively; 3. the conveyance instruction requester assigned the sending address of the storage space aggregate different from all three receiving locations, and the center website is independent from the information management system center; 4. the storage space aggregate is specified with an unique address, and the object storage spaces are widely configured at every place, and the storage space aggregate is configured with a storage space surveillance, access control authorization, information input, information transmission, and accounting management mechanism, and the environmental relationship is: A conveyance instruction requester 10 is the originator of a conveyance instruction request case for requesting the conveyance control center 2 comprising an information management system center 21, a center website 22 and a logistic center 23 to convey the object A, the object B, and the object C; and, delivering from S001 storage space aggregate 3001 to S001 storage space aggregate 3001, S002 storage space aggregate 3002, and S003 storage space aggregate 3003 for the reception by A receiver 4001, B receiver 4002, and C receiver 4003; and, asking the conveyance control center 2 to notify the A conveyance instruction requester 10 the conveyance process has been completed after receiving the information for completion of pick-up by A, B, and C receivers, respectively. The execution process is as follows:

Step 1: A conveyance instruction requester 10 will enter the request content, such as the name/title of the sender, the sending S001 storage space aggregate assigned address 3001, contact phone number, item and weight for the sending object, name or title of the receiver, the set password by the sender, the receiving S002, S003, S004 storage space aggregate assigned addresses 3001, 3002, 3003, 3004, and the storage and pick-up time, into the request page of the center website 22 through Internet.

Step 2: After the center website 22 received the request data from the A conveyance instruction requester 10, according to the request content of the requester 10, it will first confirm the payment method, and at the time issuing the approval, provide two sets or more access digital code and confirmation code sets 5001, including one set or more sending digital codes 5002, one set or more receiving digital codes 5003, 5004, 5005.

Step 3: the center website 22 will transmit all information to the information management system center 21, especially for the information of delivery method for each object, access digital code and confirmation code sets 5001.

Step 4-1: A conveyance instruction requester 10 will forward the sending digital codes 5002 obtained from the center website 22 to the A sender 12, and the A sender 12 could also be the conveyance instruction requester 10.

Step 4-2, Step 4-3, Step 4-4: A conveyance instruction requester 10 will forward the receiving digital codes 5003 obtained from the center website 22 to A receiver 4001, the receiving digital codes 5004 to B receiver 4002, and the receiving digital codes 5005 to C receiver 4003. The A, B, C receivers could also be the conveyance instruction requester 10.

Step 5: A sender 12 will attach the sending digital code 5002 on the outer package of the sending object for the same sender according to the object storing time and storage space address by the conveyance instruction request, and attach the receiving digital codes for different receivers on the outer package of different objects, so that the digital codes on the outer package of each sending object will clearly show the associated conveyance information; then, going to the S001 storage space aggregate 3001 at the assigned address, and entering the sending digital code set 5002 from the information input mechanism; after the confirmation of access authorization by the information management system center 21, and even with the accounting process for handling charge payment, the access control of the storage space will be opened, and storing the object.

Step 6-1: After storing of the sending object, S001 storage space aggregate 3001 will issue a completion and arrival notification to the information management system center 21, and starting entering the monitoring status.

Step 6-2: the information management system center 21 will immediately notify the logistic center 23 to arrange the channel, and enter the conveyance state. Step 7: the logistic center 23 will be based on the conveyance pick-up digital codes 6002 in the conveyance digital code set 6001 and the configured logistic route to pick up the stored object by the sender.

Step 8, 8-1, 8-2, 8-3: the logistic center 23 will be based on the configured logistic route to transfer to S001, S002, S003 storage space aggregates 3002, 3003, 3004, and employ another three sets of conveyance storing digital codes 6003, 6004, 6005 to place the objects into the specific storage spaces in S001, S002, S003 storage space aggregates 3002, 3003, 3004 assigned by the A conveyance instruction requester 10.

Step 9-1, 9-2, 9-3: the information transmission mechanism inside S001, S002, S003 storage space aggregates 3002, 3003, 3004 will immediately return the arrival information to the information management system center 21.

Step 10: the information management system center 21 will transmit the completion information to the center website 22, and notify the pick-up confirmation digital code.

Step 11-0, Step 11-1, Step 11-2, Step 11-3: the center website 22 will notify the arrival related personnel according to the request content provided by the A conveyance instruction requester, and provide the pick-up confirmation digital codes 7001, 7002, 7003.

Step 12-1, 12-2, 12-3: A, B, C receivers will rely on a set of receiving digital codes submitted by the A conveyance instruction requester 10, and one set of pick-up confirmation digital codes submitted by the center website 22, to pick up the objects sent by the sender from the S001, S002, S003 storage space aggregates 3002, 3003, 3004.

Step 13: S001, S002, S003 storage space aggregates 3002, 3003, 3004 will send out the idle message to notify the information management system center 21.

The above-mentioned is only one of the embodiments, and the present invention is not limited to the embodiment. The techniques in the present invention should be defined by the claims, and it should be noted that the above-mentioned steps are not necessarily completed employing the network for message transmission.

What is claimed is:

1. An unmanned object conveyance system, which comprises:
a storage space aggregate, which is configured with a surveillance system, an access control authorization system, an input device, an information transmission system, with different numbers of storage spaces;
an information management system center for controlling all information in the storage space aggregates and the logistic center;
a center website, which is in charge of the communication among conveyance instruction requester, sender, receiver, and shipper, provides all kinds of combinations of digital codes to conveyance instruction requester, sender, receiver and logistic center, and handles the messages transmitted from the information management system center;
a logistic center for conveying objects among each storage space aggregate; and,
a digital code for providing the input and authorization by the storage space aggregate from various combinations.

2. An unmanned object conveyance system according to claim 1, wherein the storage space aggregate is an aggregate configured with a plurality of storage spaces, in which the aggregate is in charge of unified providing the surveillance, access control authorization, information input, information transmission, and accounting management means by the aggregate.

3. An unmanned object conveyance system according to claim 1, wherein the access control authorization in the storage space aggregate is mainly based on the digital code and the authorization code provided by the center website.

4. An unmanned object conveyance system according to claim 1, wherein the digital code is a digital password.

5. An unmanned object conveyance system according to claim 1, wherein the digital code is a barcode.

6. An unmanned object conveyance system according to claim 1, wherein the digital code includes an access digital code, a sending digital code, a conveyance digital code, a conveyance pick-up digital code, a conveyance storing digital code, a pick-up confirmation digital code and the confirmation code thereof.

7. An unmanned object conveyance system according to claim 1, wherein the center website provides the logistic center with the digital codes for transmitting channel messages.

8. An unmanned object conveyance system according to claim 1, wherein the information management system center further comprises a center network.

9. An unmanned object conveyance system according to claim 1, wherein the storage space aggregate further comprises an accounting management system using payment mechanism for payment.

10. An unmanned object conveyance system according to claim 1, wherein the center website provides the digital codes to different targets, which is different with different information, and is unique.

11. An unmanned object conveyance system according to claim 1, wherein the conveyance instruction requester includes the sender.

12. An unmanned object conveyance system according to claim 1, wherein the conveyance instruction requester includes the receiver.

13. An unmanned object conveyance system according to claim 1, wherein the sender and the receiver further include one-to-many and many-to-one models.
